(19) United States
(12) Patent Application Publication
(10) Pub. No.: US 2024/0161267 A1
(43) Pub. Date: May 16, 2024

(54) INFORMATION PROCESSING DEVICE, DETERMINATION METHOD, AND STORAGE MEDIUM

(71) Applicant: HITACHI ZOSEN CORPORATION, Osaka-shi, Osaka (JP)

(72) Inventors: Kaoru SHINODA, Osaka-shi, Osaka (JP); Takeru KATAYAMA, Osaka-shi, Osaka (JP); Masamitsu ABE, Osaka-shi, Osaka (JP); Ryota IOKA, Osaka-shi, Osaka (JP); Takahiro WADA, Osaka-shi, Osaka (JP); Hiroshi HATTORI, Osaka-shi, Osaka (JP); Joichi MURAKAMI, Osaka-shi, Osaka (JP)

(21) Appl. No.: 18/552,965

(22) PCT Filed: Jan. 19, 2022
(86) PCT No.: PCT/JP2022/001699

§ 371 Date: Sep. 28, 2023

(30) Foreign Application Priority Data
Apr. 2, 2021 (JP) 2021-063688

(51) Int. Cl. G06T 7/00; G06V 10/42

(52) U.S. Cl. CPC G06T 7/0004; G06V 10/42; G06T 2207/30136

(57) ABSTRACT

This invention carries out highly accurate determination even on an image which is likely to cause erroneous determination. An information processing device (1) includes: a classifying section (105) that obtains an output value given in response to inputting an inspection image into a classification model generated by carrying out learning so that distances, in a feature space, between feature quantities extracted from an image group not having a noise become small; and a determining section (102) that applies, in accordance with the output value, a method for the image group not having a noise or a method for an image group having a noise to determine the presence or absence of a defect.

### TECHNICAL FIELD

The present invention relates to an information processing device and the like each of which carries out determination on the basis of an image.

### BACKGROUND ART

Conventionally, determining various determination matters with use of an image is widely carried out. For example, Patent Literature 1 indicated below discloses an ultrasonic flaw detection test involving use of phased-array Time Of Flight Diffraction (TOFD) technique. According to the ultrasonic flaw detection test, an ultrasonic beam is transmitted from a phased array flaw detecting element and is converged onto a stainless steel weld, a diffracted wave thereof used to generate an image for flaw detection (i.e., a flaw detection image), and the flaw detection image is displayed. Consequently, it is possible to detect a weld defect occurred inside the stainless steel weld.

### CITATION LIST

### Patent Literature

Patent Literature 1
Japanese Patent Application Publication, Tokukai, No. 2014-48169

### SUMMARY OF INVENTION

### Technical Problem

According to the technique of Patent Literature 1, a weld defect is detected by visually checking the flaw detection image, and therefore human cost and temporal cost required for an inspection are high, disadvantageously. A method for solving such a problem can be, for example, carrying out automatic determination of the presence or absence of a weld defect through computer analysis of a flaw detection image.

However, the flaw detection image may sometimes include a noise similar in appearance to an echo from the weld defect. In automatic determination, this noise may be erroneously determined as a weld defect. Such erroneous determination can happen not only in a flaw detection image but also in any image which may possibly include a matter similar in appearance to a detection subject. Further, also in object detection of detecting a target included in an image, it is difficult to correctly detect the target in an image like the above image.

As described above, various kinds of automatic determination processes involving use of an image have the following problem. That is, in a case where a target image which is a determination target is an image which is likely to cause erroneous determination, determination accuracy may be degraded. An aspect of the present invention has an object to realize an information processing device and the like each of which can carry out highly accurate determination even on an image which is likely to cause erroneous determination.

### Solution to Problem

In order to solve the object, an information processing device in accordance with an aspect of the present invention includes: an obtaining section that obtains an output value given in response to inputting a target image into a classification model generated by carrying out learning so that distances between feature quantities extracted from a first image group having a common feature become small when the feature quantities are embedded in a feature space; and a determining section that applies, on a basis of the output value, a first method for the first image group or a second method for a second image group, which is constituted by an image not belonging to the first image group, to determine a given determination matter relating to the target image.

In order to solve the object, a determination method in accordance with an aspect of the present invention is a determination method executed by an information processing device, including: an obtaining step of obtaining an output value given in response to inputting a target image into a classification model generated by carrying out learning so that distances between feature quantities extracted from a first image group having a common feature become small when the feature quantities are embedded in a feature space; and a determination step of applying, on a basis of the output value, a first method for the first image group or a second method for a second image group, which is constituted by an image not belonging to the first image group, to determine a given determination matter relating to the target image.

### Advantageous Effects of Invention

In accordance with an aspect of the present invention, it is possible to carry out highly accurate determination even on an image which is likely to cause erroneous determination.

### BRIEF DESCRIPTION OF DRAWINGS

FIG. 1 is a block diagram illustrating an example of a configuration of a main part of an information processing device in accordance with Embodiment 1 of the present invention.

FIG. 2 is a view illustrating an outline of an inspection system including the information processing device.

FIG. 3 is a view illustrating an outline of an inspection carried out by the information processing device.

FIG. 4 is a view illustrating an example of a configuration of a determining section included in the information processing device and an example of a method for determination of the presence or absence of a defect, carried out by the determining section.

FIG. 5 is a view illustrating an example in which feature quantities extracted, with use of a classification model, from a large number of inspection images are embedded in a feature space.

FIG. 6 is a view illustrating an example of an inspection method involving use of the information processing device.

FIG. 7 is a block diagram illustrating an example of a configuration of a main part of an information processing device in accordance with Embodiment 2 of the present invention.

FIG. 8 is a view illustrating an example of an inspection method involving use of the information processing device.

FIG. 9 is a block diagram illustrating an example of a configuration of a main part of an information processing device in accordance with Embodiment 3 of the present invention.

FIG. 10 is a view illustrating an example of an inspection method involving use of the information processing device.

FIG. 11 is a block diagram illustrating an example of a configuration of a main part of an information processing device in accordance with Embodiment 4 of the present invention.

FIG. 12 is a view illustrating an example of an inspection method involving use of the information processing device.

### DESCRIPTION OF EMBODIMENTS

### Embodiment 1

[Outline of System]

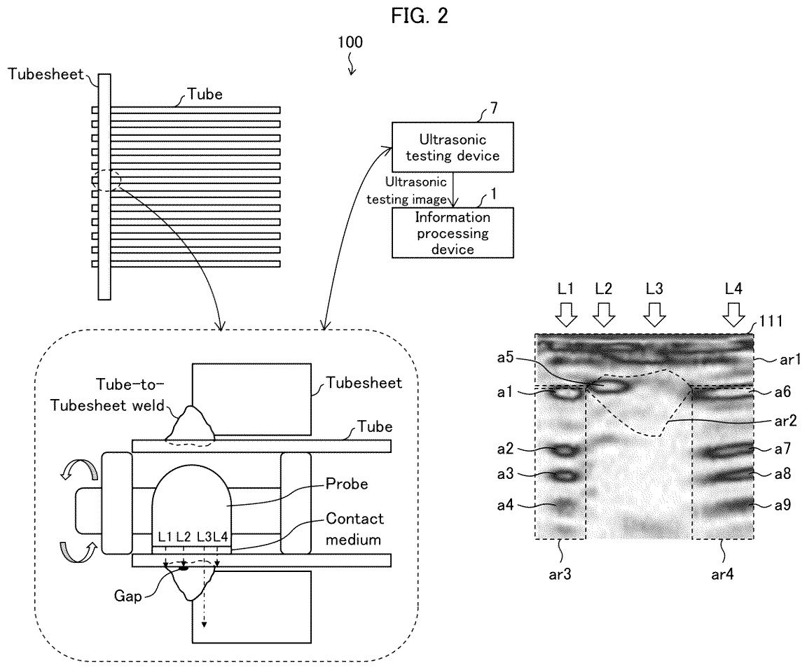

The following will describe, with reference to FIG. 2, an outline of an inspection system in accordance with an embodiment of the present invention. FIG. 2 is a view illustrating an outline of an inspection system 100. The inspection system 100 is a system that carries out an inspection to determine the presence or absence of a defect in an inspection target on the basis of an image of the inspection subject. The inspection system 100 includes an information processing device 1 and an ultrasonic testing device 7.

The description in the present embodiment will discuss an example in which the inspection system 100 carries out an inspection to determine the presence or absence of a defect in a tube-to-tubesheet weld in a heat exchanger. Note that the tube-to-tubesheet weld refers to a part in which a plurality of metal tubes constituting the heat exchanger are welded to a metal tubesheet that bundles the tubes. The defect in the tube-to-tubesheet weld refers to a gap created inside the tube-to-tubesheet weld. Note that each of the tubes and the tubesheet may be made of a nonferrous metal such as aluminum or a resin. With the inspection system 100, it is also possible to carry out an inspection to determine the presence or absence of a defect in a welded part (base welded part) between a tube support and a tube in boiler equipment used in a garbage incineration plant, for example. Needless to say, the part to be inspected is not limited to the welded part, and the inspection target is not limited to the heat exchanger.

An inspection is carried in the following manner. As shown in FIG. 2, a probe having a contact medium applied thereto is inserted through a tube end. Then, the probe emits an ultrasonic wave so that the ultrasonic wave is propagated from an inner wall surface side of the tube toward the tube-to-tubesheet weld, and measures an echo of the ultrasonic wave. If such a defect as a gap in the tube-to-tubesheet weld occurs, an echo from the cavity can be measured. On the basis of the echo, it is possible to detect the defect. Note that the contact medium and the application method thereof may be any medium and any method, provided that they enable obtaining of an ultrasonic testing image. For example, the contact medium may be water. In the case where water is used as the contact medium, the water may be supplied to the probe and its surrounding area by a pump.

For example, the lower left part of FIG. 2 shows an enlarged view of the probe and its surrounding area. In the enlarged view, an ultrasonic wave indicated by the arrow L3 is propagated in a portion of the tube-to-tubesheet weld which portion has no gap. Thus, an echo of the ultrasonic wave indicated by the arrow L3 would not be measured. Meanwhile, an ultrasonic wave indicated by the arrow L2 is propagated toward a portion of the tube-to-tubesheet weld which portion has a gap. Thus, an echo of the ultrasonic wave reflected by the gap is measured.

Further, an ultrasonic wave is reflected also by the periphery of the tube-to-tubesheet weld, and therefore an echo of the ultrasonic wave propagated in the periphery is also measured. For example, since an ultrasonic wave indicated by the arrow L1 is propagated in a part closer to the tube end than the tube-to-tubesheet weld is, the ultrasonic wave does not hit the tube-to-tubesheet weld but is reflected by a tube surface of the part closer to the tube end than the tube-to-tubesheet weld is. Thus, due to the ultrasonic wave indicated by the arrow L1, an echo coming from the tube surface is measured. Meanwhile, an ultrasonic wave indicated by the arrow L4 is reflected by a tube surface of a part of the tube-to-tubesheet weld which part is closer to the far side of the tube. Thus, an echo of that ultrasonic wave is measured.

The tube-to-tubesheet weld surrounds the tube by 360 degrees. Thus, measurement is carried out repeatedly by circumferentially moving the probe by a certain angle (e.g., 1 degree). Then, data indicating the measurement result obtained with the probe is transmitted to the ultrasonic testing device 7. For example, the probe may be an array probe constituted by a plurality of array elements. In a case where the array probe is employed, the array probe may be disposed so that a direction of arrangement of the array elements coincides with a direction in which the tube extends. With this, it is possible to effectively inspect the tube-to-tubesheet weld whose width extends in the extending direction of the tube. Alternatively, the array probe may be a matrix array probe constituted by array elements arranged in rows and columns.

With use of the data indicating the result of the measurement carried out by the probe, the ultrasonic testing device 7 generates an ultrasonic testing image that is an image of the echoes of the ultrasonic waves propagated in the tube and the tube-to-tubesheet weld. FIG. 2 illustrates an ultrasonic testing image 111, which is an example of the ultrasonic testing image generated by the ultrasonic testing device 7. Alternatively, the ultrasonic testing image 111 may be generated by the information processing device 1. In this case, the ultrasonic testing device 7 transmits, to the information processing device 1, the data indicating the measurement result obtained by the probe.

In the ultrasonic testing image 111, an intensity of a measured echo is presented as a pixel value of each pixel. An image area of the ultrasonic testing image 111 can be divided into a tube area art corresponding to the tube, a welded area ar2 corresponding to the tube-to-tubesheet weld, and peripheral echo areas ar3 and ar4 where echoes from peripheral parts of the tube-to-tubesheet weld appear.

As discussed above, the ultrasonic wave propagated from the probe in a direction indicated by the arrow L1 is reflected by the tube surface of the part closer to the tube end than the tube-to-tubesheet weld is. This ultrasonic wave is also reflected by the inner surface of the tube. These reflections occur repeatedly. Thus, repetition of echoes a1 to a4 appears in the peripheral echo area ar3, which extends along the arrow L1 in the ultrasonic testing image 111. The ultrasonic wave propagated from the probe in a direction indicated by the arrow L4 is repeatedly reflected by the outer surface and the inner surface of the tube. Thus, repetition of echoes a6 to a9 appears in the peripheral echo area ar4, which extends along the arrow L4 in the ultrasonic testing image 111. Each of these echoes, which appear in the peripheral echo areas ar3 and ar4, is also called “bottom echo”.

The ultrasonic wave propagated from the probe in a direction indicated by the arrow L3 is not reflected by anything. Thus, no echo appears in an area extending along the arrow L3 in the ultrasonic testing image 111. Meanwhile, the ultrasonic wave propagated from the probe in a direction indicated by the arrow L2 is reflected by the gap, i.e., the defect portion in the tube-to-tubesheet weld. Thus, an echo a5 appears in an area extending along the arrow L2 in the ultrasonic testing image 111.

The information processing device 1 analyzes such an ultrasonic testing image 111 to carry out an inspection to determine the presence or absence of a defect in the tube-to-tubesheet weld (details thereof will be described later). Further, the information processing device 1 may also determine the type of the defect. For example, if the information processing device 1 determines that a defect is present, the information processing device 1 may determine to which one of features known as a defect in the weld the defect corresponds, from among incomplete penetration in the first layer, incomplete fusion between welding passes, undercut, and a blowhole.

As discussed above, the inspection system 100 includes: the ultrasonic testing device 7 that generates an ultrasonic testing image 111 of a tube-to-tubesheet weld; and the information processing device 1 that analyzes the ultrasonic testing image 111 to carry out an inspection to determine the presence or absence of a defect in the tube-to-tubesheet weld. Further, the information processing device 1 obtains an output value given in response to inputting an inspection image generated from the ultrasonic testing image 111 into a classification model generated by carrying out learning so that distances between feature quantities extracted from an image group not including a noise become small when the feature quantities are embedded in a feature space, and applies, on the basis of the output value, a first method for an image not including a noise or a second method for an image including a noise to determine the presence or absence of a defect (details thereof will be described later). With this, even in a case where the ultrasonic testing image 111 includes a noise having an appearance that can be mistaken as an echo from a defect portion, it is possible to determine the presence or absence of a defect with high accuracy. [Configuration of Information Processing Device]

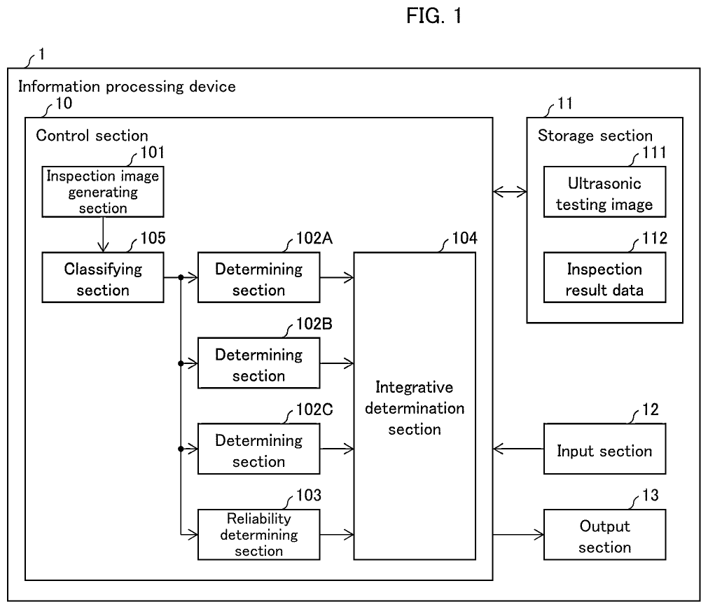

The following description will discuss a configuration of the information processing device 1 with reference to FIG. 1. FIG. 1 is a block diagram illustrating an example of a configuration of a main part of the information processing device 1. As shown in FIG. 1, the information processing device 1 includes: a control section 10 which comprehensively controls the sections of the information processing device 1; and a storage section 11 in which various data used by the information processing device 1 is stored. The information processing device 1 further includes an input section 12 which accepts an input manipulation on the information processing device 1 and an output section 13 through which the information processing device 1 outputs data.

The control section 10 includes an inspection image generating section 101, a determining section 102A, a determining section 102B, a determining section 102C, a reliability determining section 103, an integrative determination section (determining section) 104, and a classifying section (obtaining section) 105. The storage section 11 has an ultrasonic testing image 111 and inspection result data 112 stored therein. In the description below, each of the determining sections 102A, 102B, and 102C will be referred to simply as a determining section 102, in a case where there is no need to distinguish the determining sections 102A, 102B, and 102B from each other.

The inspection image generating section 101 cuts an inspection target area from the ultrasonic testing image 111, so as to generate an inspection image used to determine the presence or absence of a defect in the inspection target. A method for generating the inspection image will be described in detail later.

The determining section 102 determines, together with the integrative determination section (determining section) 104, a given determination matter in accordance with a target image. In an example discussed in the present embodiment, the target image is an inspection image generated by the inspection image generating section 101, and the given determination matter is the presence or absence of a weld defect in a tube-to-tubesheet weld in a heat exchanger captured in the inspection image. In the description below, the weld defect may simply be abbreviated as “defect”.

Note that the “defect” that is a determination target may be defined in advance in accordance with the purpose and/or the like of the inspection. For example, in a case of a quality inspection of a tube-to-tubesheet weld in a manufactured heat exchanger, it may be determined that a “defect” is present when the inspection image includes an echo caused by a gap inside the tube-to-tubesheet weld or a non-allowable recess on a surface of the tube-to-tubesheet weld. Such a recess is caused by burn-through, for example. The “presence or absence of a defect” can be reworded as the presence or absence of a portion (abnormal portion) different from that in a normal product. In the field of nondestructive inspection, an abnormal portion detected with use of an ultrasonic waveform or an ultrasonic testing image is generally called “flaw”. The “flaw” is also encompassed in the “defect”. In addition, the “defect” further encompasses chipping and cracking.

Each of the determining sections 102A, 102B, and 102C determines the presence or absence of a defect in accordance with an inspection image generated by the inspection image generating section 101. However, the determining methods of the determining sections 102A, 102B, and 102C differ from each other, as will be described later.

The determining section 102A determines the presence or absence of a defect on the basis of an output value given in response to inputting the inspection image into a learned model generated by machine learning. More specifically, the determining section 102A determines the presence or absence of a defect with use of a generated image generated in response to inputting the inspection image into a generation model that is a learned model generated by machine learning. Further, the determining section 102B analyzes pixel values in the inspection image to identify an inspection target portion in the inspection image, and determines the presence or absence of a defect on the basis of the pixel values in the inspection target portion thus identified.

Similarly to the determining section 102A, the determining section 102C also determines the presence or absence of a defect on the basis of an output value given in response to inputting the inspection image into a learned model generated by machine learning. More specifically, the determining section 102C determines the presence or absence of a defect on the basis of an output value given in response to inputting the inspection image into a determination model subjected to machine learning so as to output the presence or absence of a defect in response to the inspection image inputted thereto. Details of the determinations carried out by the determining sections 102A to 102C and various models to be used will be described later.

For each of the determination results given by the determining sections 102A to 102C, the reliability determining section 103 determines a reliability, which is an indicator indicating a degree of certainty of the determination result. Specifically, the reliability determining section 103 determines, on the basis of an output value given in response to inputting the inspection image having been used by the determining section 102A to derive the determination result into a reliability prediction model for the determining section 102A, the reliability of the determining section 102A at the time of carrying out determination on the inspection image.

The reliability prediction model for the determining section 102A can be generated by carrying out learning that uses training data in which a test image is associated with, as correct data, information indicating whether or not a result of determination carried out by the determining section 102A in accordance with that test image is correct. The test image may be any one, provided that it is generated from an ultrasonic testing image 111 for which the presence or absence of a defect is known.

Inputting the inspection image 111A into the reliability prediction model generated in this manner results in output of a value, ranging from 0 to 1, which indicates the probability that a result of determination carried out by the determining section 102A with use of the inspection image 111A is correct. Thus, the reliability determining section 103 can use an output value from the reliability prediction model as the reliability of the determination result of the determination result 102A. A reliability prediction model for the determining section 102B and a reliability prediction model for the determining section 102C can be generated in a similar manner. Further, the reliability determining section 103 determines a reliability of a determination result of the determining section 102B with use of the reliability prediction model for the determining section 102B, and determines a reliability of a determination result of the determining section 102C with use of the reliability prediction model for the determining section 102C.

The integrative determination section 104 determines the presence or absence of a defect with use of (i) the determination results of the determining sections 102A to 102C and (ii) the reliabilities determined by the reliability determining section 103. With this, it is possible to obtain a determination result in appropriate consideration of the determination results of the determining sections 102A to 102C with reliabilities corresponding to the inspection image. Details of the determination method carried out by the integrative determination section 104 will be described later.

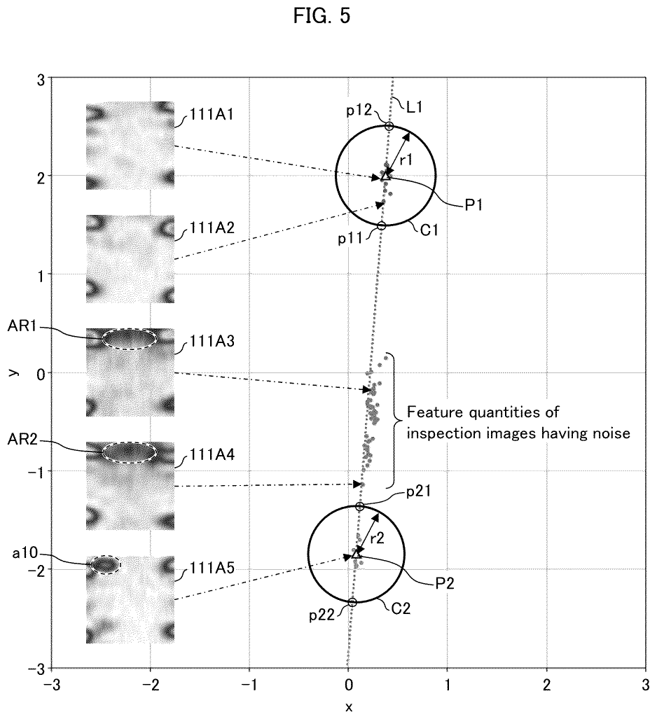

The classifying section 105 carries out classification of an inspection image with use of a given classification model. The classification model is a model generated by carrying out learning so that distances between feature quantities extracted from a first image group having a common feature become small when the feature quantities are embedded in a feature space (details thereof will be described later with reference to FIG. 5). The “common feature” means that the images do not include a noise. The classifying section 105 obtains an output value given in response to inputting an inspection image into the classification model.

Then, in accordance with the output value obtained by the classifying section 105, the determining section 102 applies the first method for the first image group or a second method for a second image group, which is constituted by an image not belonging to the first image group, to determine the presence or absence of a defect.

Specifically, the output value obtained by the classifying section 105 indicates that the inspection image is an image having a noise or an image not having a noise. In a case where the output value indicates that the inspection image is an image not having a noise, the first method for the inspection image not having a noise is applied. Meanwhile, in a case where the output value indicates that the inspection image is an image having a noise, the second method for the inspection image having a noise is applied.

The first method is, specifically, a method according to which the integrative determination section 104 determines the presence or absence of a defect with use of the determination results of the determining sections 102A to 102C and their reliabilities determined by the reliability determining section 103. Meanwhile, the second method is a method according to which the determining section 102B determines the presence or absence of a defect.

As discussed above, the ultrasonic testing image 111 is an image of echoes of ultrasonic waves propagated in the inspection target, and is generated by the ultrasonic testing device 7.

The inspection result data 112 is data indicating a result of a defect inspection carried out by the information processing device 1. In the inspection result data 112, information which indicates the presence or absence of a defect regarding the ultrasonic testing image 111 and which is stored in the storage section 11 is recorded. In a case where the type of the defect is determined, the determination result regarding the type of the defect may be recorded as the inspection result data 112.

As discussed above, the information processing device 1 includes: the classifying section 105 that obtains an output value given in response to inputting an inspection image into a classification model generated by carrying out learning so that distances between feature quantities extracted from an image group not having a noise (a first image group having a common feature) become small when the feature quantities are embedded in a feature space; and the determining section 102 that applies, in accordance with the output value, the first method for the first image group or the second method for the image group having a noise (the second image group constituted by an image not belonging to the first image group) to determine the presence or absence of a defect (a given determination matter relating to the inspection image).

The classification model is generated by carrying out learning so that the distances between the feature quantities become small when the feature quantities are embedded in the feature space. Thus, even in a case where the inspection image is an image which includes a noise and which is likely to cause erroneous determination, inputting the inspection image into the classification model can yield an output value indicating whether or not the feature quantity of the inspection image is close to a feature quantity of the first image group not having a noise.

That is, if the feature quantity of the inspection image is close to the feature quantity of the first image group not having a noise, the inspection image can be considered as highly likely not to include a noise. Meanwhile, if the feature quantity of the inspection image deviates from the feature quantity of the first image group not having a noise, the inspection image can be considered as highly likely to include a noise. Typically, irregular noises have various forms, and therefore it is difficult to collect adequate training data therefor. Thus, it is difficult to determine the presence or absence of a noise with use of a learned model generated by machine learning. However, use of an output value such as the above-described one makes it possible to determine whether or not the inspection image includes a noise.

Further, with the above configuration, in accordance with the above output value, the first method for an image not having a noise or the second method for an image having a noise is applied to carry out determination of a determination matter. This makes it possible to apply an appropriate method suitable for the feature of the inspection image, thereby making it also possible to carry out highly accurate determination even on an inspection image which is likely to cause erroneous determination.

[Outline of Inspection]

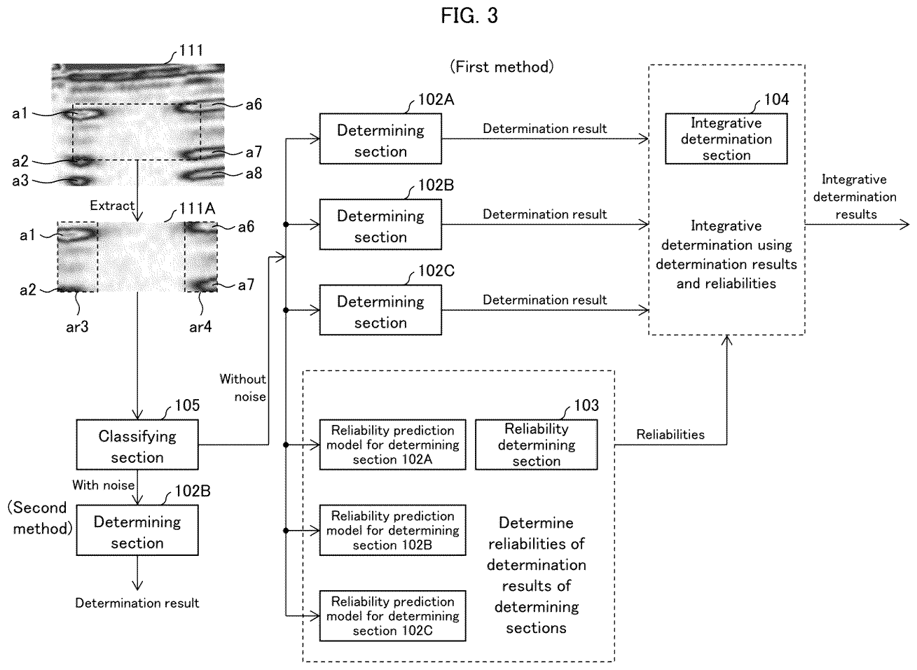

The following description will discuss, with reference to FIG. 3, an outline of an inspection carried out by the information processing device 1. FIG. 3 is a view illustrating an outline of an inspection carried out by the information processing device 1. Note that FIG. 3 shows a process to be carried out after the ultrasonic testing image 111 generated by the ultrasonic testing device 7 is stored in the storage section 11 of the information processing device 1.

First, the inspection image generating section 101 extracts an inspection target area from the ultrasonic testing image 111 to generate an inspection image 111A. The extraction of the inspection target area may be carried out with use of an extraction model constructed by machine learning. The extraction model can be constructed by any learning model suitable for extraction of an area from an image. For example, the inspection image generating section 101 may construct the extraction model by You Only Look Once (YOLO) or the like that involves excellent extraction accuracy and excellent processing speed.

The inspection target area refers to an area sandwiched between two peripheral echo areas ar3 and ar4 in each of which an echo coming from the periphery of an inspection target portion of the inspection target appears repeatedly. As shown in FIG. 2, in the periphery of the inspection target portion in the ultrasonic testing image 111, a given echo caused by the shape and/or the like of the peripheral part is repeatedly observed (echoes a1 to a4 and echoes a6 to a9). Thus, on the basis of the positions of the peripheral echo areas ar3 and ar4 in each of which such an echo repeatedly appears, it is possible to identify the area corresponding to the inspection target portion of the ultrasonic testing image 111. Note that it is not only the ultrasonic testing image 111 of the tube-to-tubesheet weld that a given echo appears in the periphery of an inspection target portion. Thus, the configuration that extracts, as the inspection target area, an area surrounded by the peripheral echo areas is applicable also to inspections on parts other than the tube-to-tubesheet weld.

Subsequently, the classifying section 105 carries out classification of the inspection image 111A. Then, for an inspection image 111A classified by the classifying section 105 as an image having a noise, determination of the presence or absence of a defect is carried out by the second method, as described above. Specifically, as shown in FIG. 3, for the inspection image 111A classified by the classifying section 105 as an image having a noise, the determining section 102B determines the presence or absence of a defect through numerical analysis. Then, a result thereof is added to the inspection result data 112. The determining section 102B may cause the output section 13 to output the determination result.

Meanwhile, for an inspection image 111A classified by the classifying section 105 as an image not having a noise, determination of the presence or absence of a defect is carried out by the first method. Specifically, first, the determining sections 102A, 102B, and 102C determine the presence or absence of a defect on the basis of the inspection image 111A. Details of the determination will be described later.

Then, the reliability determining section 103 determines reliabilities of the determination results given by the determining sections 102A, 102B, and 102C. Specifically, the reliability of the determination result of the determining section 102A is determined in accordance with an output value given in response to inputting the inspection image 111A into the reliability prediction model for the determining section 102A. Similarly, the reliability of the determination result given by the determining section 102B is determined in accordance with an output value given in response to inputting the inspection image 111A into the reliability prediction model for the determining section 102B. The reliability of the determination result given by the determining section 102C is determined in accordance with an output value given in response to inputting the inspection image 111A into the reliability prediction model for the determining section 102C.

Then, the integrative determination section 104 carries out integrative determination on the presence or absence of a defect in accordance with (i) the determination results of the determining sections 102A, 102B, and 102C and (ii) the reliabilities of the determination results determined by the reliability determining section 103, and outputs a result of the integrative determination. This result is added to the inspection result data 112. The integrative determination section 104 may cause the output section 13 to output the result of the integrative determination.

In the integrative determination, the determination results of the determining section 102 may be represented by numerical values, and the reliabilities determined by the reliability determining section 103 may be used as weights. For example, if the determining sections 102A, 102B, and 102C determine that a defect is present, “1” is output as the determination result. Meanwhile, if the determining sections 102A, 102B, and 102C determine that a defect is absent, “−1” is output as the determination result. The reliability determining section 103 outputs reliabilities within a numerical range from 0 to 1 (a value closer to 1 indicates a higher reliability). In this case, the integrative determination section 104 may calculate a total value obtained by summing up values obtained by multiplying (i) the values (“1” or “−1”) output by the determining sections 102A, 102B, and 102C by (ii) the reliabilities output by the reliability determining section 103. Then, the integrative determination section 104 may determine the presence or absence of a defect in accordance with whether or not the total value thus calculated is higher than a given threshold.

For example, assume that the threshold is set at “0”, which is intermediate between “1” indicating that a defect is present and “−1” indicating that a defect is absent. Assume also that the output values of the determining sections 102A, 102B, and 102C are respectively “1”, “−1”, and “1” and the reliabilities thereof are respectively “0.87”, “0.51”, and “0.95”.

In this case, the integrative determination section 104 carries out calculation as follows: 1×0.87+(−1)×0.51+1×0.95. The result of the calculation is 1.31, which is higher than “0”, i.e., the threshold. Thus, the result of the integrative determination made by the integrative determination section 104 indicates that a defect is present.

[Determination by Determining Section 102A]

As discussed above, the determining section 102A determines the presence or absence of a defect with use of a generated image given in response to inputting an inspection image into a generation model. The generation model is constructed by machine learning that uses, as training data, an image of an inspection target in which a defect is absent, so that the generation model generates a new image having a similar feature quantity to that of an image inputted into the generation model. Note that the “feature quantity” is any information obtained from an image. For example, a distribution state, a variance, and the like of pixel values in the image are also included in the “feature quantity”.

The generation model is constructed by machine learning that uses, as training data, an image of an inspection target in which a defect is absent. Thus, if an image of an inspection target in which a defect is absent is inputted into the generation model as the inspection image, it is highly likely that a new image having a similar feature quantity to that of the inspection image is outputted as a generated image.

Meanwhile, if an image of an inspection target in which a defect is present is inputted into the generation model as the inspection image, it is highly likely that a resulting generated image has a different feature quantity from that of the inspection image, regardless of the position, shape, and size of the defect captured in the inspection image.

As discussed above, (i) the generated image generated from the inspection image in which a defect is captured and (ii) the generated image generated from the inspection image in which no defect is captured differ from each other in that one does not properly reconstruct the target image inputted into the generation model and the other properly restores the target image inputted into the generation model.

Thus, with the information processing device 1 that carries out integrative determination in consideration of the determination result of the determining section 102A that determines the presence or absence of a defect with use of a generated image generated by the generation model, it is possible to determine, with high accuracy, the presence or absence of a defect having irregularity in position, size, shape, and/or the like.

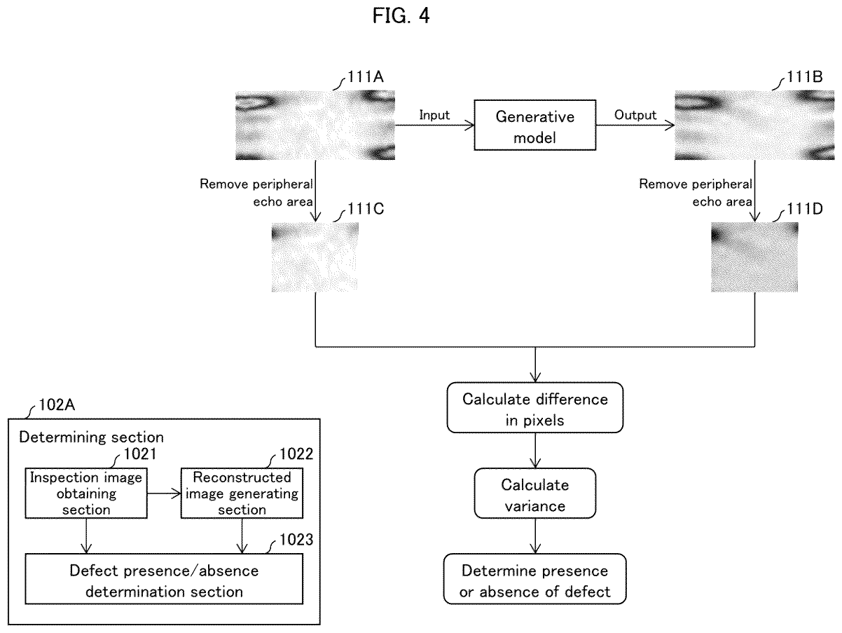

The following description will discuss, with reference to FIG. 4, details of determination made by the determining section 102A. FIG. 4 is a view illustrating an example of a configuration of the determining section 102A and an example of a method for determination of the presence or absence of a defect, carried out by the determining section 102A. As shown in FIG. 4, the determining section 102A includes an inspection image obtaining section 1021, a reconstructed image generating section 1022, and a defect presence/absence determination section 1023.

The inspection image obtaining section 1021 obtains an inspection image. As discussed above, the information processing device 1 includes the inspection image generating section 101. Thus, the inspection image obtaining section 1021 obtains an inspection image generated by the inspection image generating section 101. Note that the inspection image may be generated by the other device. In this case, the inspection image obtaining section 1021 obtains an inspection image generated by the other device.

The reconstructed image generating section 1022 inputs, into the generation model, the inspection image obtained by the inspection image obtaining section 1021, so as to generate a new image having a similar feature quantity to that of the inspection image thus input. Hereinafter, the image generated by the reconstructed image generating section 1022 is called “reconstructed image”. The generation model used to generate the reconstructed image is also called “autoencoder”, and is constructed by machine learning that uses, as training data, an image of an inspection target in which a defect is absent (details thereof will be described later). Note that the generation model may be a model obtained by improving or modifying the autoencoder. For example, the generation model may be a variational autoencoder or the like.

The defect presence/absence determining section 1023 determines the presence or absence of a defect in the inspection target with use of the reconstructed image generated by the reconstructed image generating section 1022. Specifically, the defect presence/absence determining section 1023 determines that a defect is present in the inspection target, if a variance of pixel-by-pixel difference values between the inspection image and the reconstructed image exceeds a given threshold. In the method for determining, by the determining section 102A configured as above, the presence or absence of a defect, the inspection image obtaining section 1021 first obtains the inspection image 111A. Then, the inspection image obtaining section 1021 transmits the obtained inspection image 111A to the reconstructed image generating section 1022. As discussed above, the inspection image 111A is an image generated by the inspection image generating section 101 from the ultrasonic testing image 111.

Then, the reconstructed image generating section 1022 inputs the inspection image 111A into the generation model, so as to generate a reconstructed image 111B in accordance with a resulting output value. Then, the inspection image obtaining section 1021 removes the peripheral echo areas from the inspection image 111A to generate a removed image 111C, and removes the peripheral echo areas from the reconstructed image 111B to generate a removed image (restored) 111D. Note that the positions and sizes of the peripheral echo areas captured in the inspection image 111A are substantially the same, provided that the same inspection target is captured. Thus, the inspection image obtaining section 1021 may remove, as a peripheral echo area, a given range in the inspection image 111A. The inspection image obtaining section 1021 may analyze the inspection image 111A to detect the peripheral echo areas, and may remove the peripheral echo areas in accordance with a detection result.

As a result of removing the peripheral echo areas in the above-described manner, the defect presence/absence determining section 1023 carries out determination of the presence or absence of a defect with respect to a remaining image area obtained by removing the peripheral echo areas from the image area of the reconstructed image 111B. Consequently, it is possible to carry out the determination of the presence or absence of a defect without being affected by an echo coming from the periphery. This makes it possible to improve the accuracy in determination of the presence or absence of a defect.

Next, the defect presence/absence determining section 1023 determines the presence or absence of a defect. Specifically, the defect presence/absence determining section 1023 first calculates, in pixels, a difference between the removed image 111C and the removed image (restored) 111D. Next, the defect presence/absence determining section 1023 calculates a variance of the difference thus obtained. Then, the defect presence/absence determining section 1023 determines the presence or absence of a defect in accordance with whether or not the value of the variance thus calculated exceeds a given threshold.

A difference value calculated for a pixel in which an echo caused by a defect appears is higher than difference values calculated for the other pixels. Thus, a variance of difference values calculated for a removed image 111C and a removed image (restored) 111D generated from an inspection image 111A where an echo caused by a defect is captured is large.

Meanwhile, a variance of difference values calculated for a removed image 111C and a removed image (restored) 111D generated from an inspection image 111A where an echo caused by a defect is not captured is relatively small. The reason is that, in the case where the echo caused by the defect is not captured, a part having somewhat high pixel values due to the effects of noises and/or the like can occur, but a part having extremely high pixel values occurs with low probability.

The increase in variance of difference values is a phenomenon characteristic to a case where the inspection target has a defect. Thus, with the defect presence/absence determining section 1023 configured to determine that a defect is present if a variance of difference values exceeds a given threshold, it is possible to appropriately determine the presence or absence of a defect.

Note that a timing to remove the peripheral echo areas is not limited to the above-described example. Alternatively, for example, a difference image between the inspection image 111A and the reconstructed image 111B may be generated, and the peripheral echo areas may be removed from the difference image.

[Determination by Determining Section 102B]

As discussed above, the determining section 102B analyzes pixel values in the inspection image, which is an image of the inspection target, to identify an inspection target portion in the inspection image, and determines the presence or absence of a defect in accordance with pixel values in the inspection target portion thus identified.

In a conventional inspection involving use of an image, an inspector visually carries out a process of identifying an inspection target portion in an image and checking, in the identified portion, for a defect such as a damage and/or a gap that should not exist from a design standpoint. Such a visual inspection is requested to be automated, from the viewpoints of reduction of labor, achievement of stable accuracy, and/or the like.

The determining section 102B analyzes the pixel values in the image to identify an inspection target portion in the image, and determines the presence or absence of a defect in accordance with pixel values in the inspection target portion thus identified. Thus, it is possible to automate the above-described visual inspection. Further, for an inspection image classified as an image not having a noise, the information processing device 1 carries out determination by comprehensively considering the determination result given by the determining section 102B and the determination result(s) of other determining section(s) 102. This makes it possible to determine the presence or absence of a defect with high accuracy. Meanwhile, for an inspection image classified as an image having a noise, the information processing device 1 analyzes the pixel values. This makes it possible to determine the presence or absence of a defect with high accuracy, while avoiding a situation in which a noise is erroneously determined as a defect.

The following will give a more detailed description of the content of a process (numerical analysis) to be executed by the determining section 102B. First, in the inspection image, the determining section 102B identifies, as the inspection target portion, an area sandwiched between two peripheral echo areas (peripheral echo areas ar3 and ar4 in the example shown in FIG. 2) in each of which an echo coming from the periphery of the inspection target portion appears repeatedly. Then, the determining section 102B determines the presence or absence of a defect on the basis of whether or not the identified inspection target portion includes an area (also called “defect area”) constituted by pixel values not less than a threshold.

In order to detect the peripheral echo areas and the defect area, the determining section 102B may first binarize the inspection image 111A with use of a given threshold to generate a binarized image. Then, the determining section 102B detects the peripheral echo areas from the binarized image. For example, the inspection image 111A shown in FIG. 3 includes echoes a1, a2, a6, and a7. By binarizing the inspection image 111A with use of such a threshold that can divide these echoes and noise components from each other, the determining section 102B can detect these echoes in the binarized image. Then, the determining section 102B can detect edges of these echoes thus detected, and can identify, as the inspection target portion, an area surrounded by these edges.

To be more specific, the determining section 102B identifies a right edge of the echo a1 or a2 as a left edge of the inspection target portion, and identifies a left edge of the echo a6 or a7 as a right edge of the inspection target portion. These edges constitute boundaries between (i) the peripheral echo areas ar3 and ar4 and (ii) the inspection target portion. Similarly, the determining section 102B identifies an upper edge of the echo a1 or a6 as an upper edge of the inspection target portion, and identifies a lower edge of the echo a2 or a7 as a lower edge of the inspection target portion.

Note that, as in the ultrasonic testing image 111 shown in FIG. 2, an echo caused by a defect may appear at a location above the echoes a1 and a6. Thus, the determining section 102B may set the upper edge of the inspection target portion at a location above the upper edge of the echo a1 or a6.

Further, the determining section 102B can analyze the inspection target portion identified in the binarized image to determine whether or not the echo caused by the defect is captured therein. For example, in a case where the inspection target portion includes a continuous area constituted by a given number or more of pixels, the determining section 102B may determine that the echo caused by the defect is captured at a location where the continuous area exists.

Note that the above-described numerical analysis is shown as one example, and the content of the numerical analysis is not limited to the above-described example. For example, in a case where there exists a significant difference between (i) a variance of pixel values in the inspection target portion having a defect and (ii) a variance of pixel values in the inspection target portion not having a defect, the determining section 102B may determine the presence or absence of a defect in accordance with the value of the variance.

Further, for example, the determining section 102B may determine the presence or absence of a defect through numerical analysis carried out on the basis of a simulation result of an ultrasonic beam simulator. For an artificial flaw set at an arbitrary position in a test piece, the ultrasonic beam simulator outputs a height of a reflected echo obtained during detection of the artificial flaw. Thus, the determining section 102B can determine the presence or absence of a defect and/or the position of the defect by comparing (i) heights of reflected echoes corresponding to artificial flaws at various positions which heights are outputted from the ultrasonic beam simulator and (ii) a reflected echo of the inspection image.

[Determination by Determining Section 102C]

As discussed above, the determining section 102C determines the presence or absence of a defect in accordance with an output value given in response to inputting the inspection image into a determination model. The determination model is constructed by, e.g., carrying out machine learning with use of (i) training data generated by using an ultrasonic testing image 111 of an inspection target in which a defect is present and (ii) training data generated by using an ultrasonic testing image 111 of an inspection target in which a defect is absent.

The determination model can be constructed by any learning model suitable for image classification. For example, the determination model may be constructed by, e.g., convolutional neural network excellent in image classification accuracy.

[Classification Model]

The following description will discuss, with reference to FIG. 5, the classification model that the classifying section 105 uses for classification of an inspection image. FIG. 5 is a view illustrating an example in which feature quantities extracted, with use of the classification model, from a large number of inspection images are embedded in a feature space.

The classification model is generated by carrying out learning so that distances between feature quantities become small when the feature quantities are embedded in a feature space, the feature quantities having been extracted from an image group (first image group) not having a noise among image groups of an inspection target. More specifically, the classification model is generated by carrying out learning so that (i) distances between feature quantities extracted from an image group not having a noise but having a defect become small and (ii) distances between feature quantities extracted from an image group not having a noise or a defect become small. That is, this classification model is a model that classifies inspection images into two classes, i.e., a class not having a noise but having a defect and a class not having a noise or a defect.

The feature space shown in FIG. 5 is a two-dimensional feature space defined by x, which is a horizontal axis, and y, which is a vertical axis. Further, FIG. 5 also shows some of the inspection images from which the feature quantities have been extracted (inspection images 111A1 to 111A5). Among the inspection images shown in FIG. 5, the inspection images 111A1 and 111A2 are images in which no noise or not defect is included, i.e., an image not having a noise or a defect. Meanwhile, the inspection images 111A3 and 111A4 are images in each of which a noise is included in an area AR1 or AR2, i.e., an image having a noise. Further, the inspection image 111A5 is an image in which no noise is included but an echo a10 of a defect is included, i.e., an image not having a noise but having a defect.

As shown in FIG. 5, when the feature quantities respectively extracted from the inspection images with use of the classification model generated by the above-described learning are embedded in the feature space, feature quantities of inspection images belonging to the same class are plotted at locations close to each other.

Specifically, feature quantities of inspection images not having a noise or a defect, such as the inspection images 111A1 and 111A2, are substantially housed inside a circle C1, which is centered on a point P1 and which has a radius r1. Further, a feature quantity of an inspection image not having a noise but having a defect, such as the inspection image 111A5, is substantially housed inside a circle C2, which is centered on a point P2 and which has a radius r2.

Meanwhile, feature quantities of inspection images having a noise, such as the inspection images 111A3 and 111A4, are plotted at locations separated away from the circles C1 and C2. This shows that use of the model that classifies inspection images into two classes, i.e., a class not having a noise but having a defect and a class not having a noise or a defect makes it possible to distinguish an inspection image having a noise and an inspection image not having a noise from each other.

For example, if a feature quantity given in response to inputting an inspection image into the classification model is plotted at a location inside the circle C1, the classifying section 105 may classify the inspection image as an image not having a defect. For another example, if a feature quantity given in response to inputting an inspection image into the classification model is plotted at a location inside the circle C2, the classifying section 105 may classify the inspection image as an image having a defect. Meanwhile, if a feature quantity given in response to inputting an inspection image into the classification model is plotted at a location not included in the circle C1 or the circle C2, the classifying section 105 may classify the inspection image as an image having a noise.

Note that the radius r1 of the circle C1 and the radius r2 of the circle C2 may be identical to each other or may be different from each other. For example, each of the radius r1 and the radius r2 may be set at an appropriate value. For another example, a distance from a center of the feature quantity plots of training data to one of the plots farthest away from the center may be set as the radius. For further another example, a value obtained by multiplying, by 2, a standard deviation (o) of the feature quantity plots of the training data may be set as the radius.

The locations of the plots of the feature quantities of the inspection images may each be represented by a numerical value ranging from 0 to 1. For example, the location of the point P1 may be set at (0,0) and the location of the point P2 may be set at (0,1). Then, the plots of the feature quantities of the inspection images may be projected onto a straight line L connecting the points P1 and P2.

In this case, in a case where a feature quantity are plotted in a range from a point p11 to a point p12 on the straight line L, an inspection image corresponding to the feature quantity can be determined as not having a noise or a defect. Note that the point p11 is, among intersections of the circle C1 and the straight line L1, an intersection closer to the circle C2. Further, the point p12 is, among the intersections of the circle C1 and the straight line L1, an intersection farther from the circle C2.

Similarly, in a case where a feature quantity is plotted in a range from a point p21 to a point p22 on the straight line L, an inspection image corresponding to the feature quantity can be determined as not having a noise but having a defect. Note that the point p21 is, among intersections of the circle C2 and the straight line L1, an intersection closer to the circle C1. Further, the point p22 is, among the intersections of the circle C2 and the straight line L1, an intersection farther from the circle C1.

Further, in a case where a feature quantity is plotted in a range from the point p11 to the point p21, an inspection image corresponding to the feature quantity can be determined as having a noise.

Note that a value of a plot which is on the straight line L and which is located outward of the point P1 (on a side father away from the circle C2) may be regarded as 0, and a value of a plot which is on the straight line L and which is located outward of the point P2 (on a side father away from the circle C1) may be regarded as 1. Further, a value of a plot inside the circle C1 may also be regarded as 0, and a value of a plot inside the circle C2 may also be regarded as 1. In this case, an inspection image corresponding to a plot having a value of 0 is classified as not having a defect, an inspection image corresponding to a plot having a value of 1 is classified as having a defect, and an inspection image corresponding to a plot having a value which is not 0 or 1 is classified as having a noise.

Further, even in a case of using a classification model having carried out learning only with an inspection image not having a noise or a defect or only with an inspection image not having a noise but having a defect, it is possible to classify an inspection image as having a noise or as not having a noise, in a similar manner.

As discussed above, the classifying section 105 uses an output value from the classification model generated by carrying out learning so that distances between feature quantities extracted from an image group not having a noise become small when the feature quantities are embedded in a feature space. With this, the classifying section 105 can classify an inspection image as having a noise or as not having a noise. Note that the classification model may be designed to output an output value (e.g., a certainty of each class) indicating a classification result or may be designed to output a feature quantity. Note that the certainty is a numerical value which ranges from 0 to 1 and which indicates a degree of certainty of a classification result.

The classification model such as the above-discussed one can be generated by, for example, deep metric learning. The deep metric learning is a technique carrying out learning so that, for feature quantities embedded in a feature space, a distance Sn between feature quantities of pieces of data belonging to the same class becomes small and a distance Sp between feature quantities of pieces of data belonging to different classes becomes large. During the learning, the distance between the feature quantities can be expressed by, e.g., a Euclidean distance or by an angle.

Note that the inventors of the present invention attempted to carry out, with use of a classification model of a convolutional neural network, classification of an inspection image having a noise and an inspection image not having a noise. However, it was difficult to carry out the classification with use of this classification model. This shows that, in order to distinguish an inspection image having a noise and an inspection image not having a noise from each other, it is important to use the classification model generated by carrying out learning so that the distances between the feature quantities become small when the feature quantities are embedded in the feature space. [Flow of Process in Inspection]

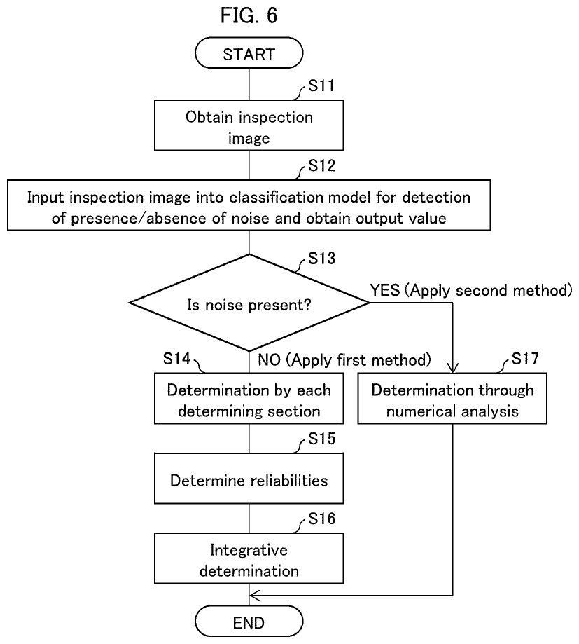

The following description will discuss, with reference to FIG. 6, a flow of a process (determination method) in an inspection. FIG. 6 is a view illustrating an example of an inspection method involving use of the information processing device 1. Assume that, at the time of start of the process in FIG. 6, an ultrasonic testing image 111 which is generated by the method explained with reference to FIG. 2 and which is used for flaw detection in a tube-to-tubesheet weld and its peripheral portion is stored in the storage section 11, and the inspection image generating section 101 has already generated an inspection image from the ultrasonic testing image 111.

In S11, the classifying section 105 obtains the inspection image generated by the inspection image generating section 101. Subsequently, in S12 (obtaining step), the classifying section 105 inputs the inspection image obtained in S11 into the above-described classification model to obtain an output value from the classification model. Further, in S13, the classifying section 105 determines, on the basis of the output value obtained in S12, whether the inspection image obtained in S11 is an inspection image having a noise or an inspection image not having a noise.

If the classifying section 105 determines, in S13, that the inspection image is an inspection image having a noise (YES in S13), the process advances to S17. Then, in S17 (determination step), determination of the presence or absence of a defect in the inspection image is carried out by the second method for an inspection image having a noise, i.e., the determining section 102B that carries out numerical analysis of pixel values of the inspection image, and a result of the determination is recorded in inspection result data 112.

Meanwhile, if the classifying section 105 determines, in S13, that the inspection image is an inspection image not having a noise (NO in S13), the process advances to S14. Then, in S14 to S16 (determination step), determination of the presence or absence of a defect in the inspection image is carried out by the first method for an inspection image not having a noise, i.e., the determining section 102A, the determining section 102C, and other section(s) that determine the presence or absence of a defect with use of a learned model.

Specifically, in S14, each of the determining sections 102A, 102B, and 102C determines the presence or absence of a defect. In S15 following S14, the reliability determining section 103 determines reliabilities of the determination results of the determining sections 102A, 102B, and 102C. Note that the process in S15 may be carried out before S14 or in parallel with S14.

Then, in S16, the integrative determination section 104 determines the presence or absence of a defect with use of the determination results obtained in S14 and the reliabilities determined in S15. Specifically, the integrative determination section 104 determines the presence or absence of a defect with use of numerical values obtained by summing up the values obtained by weighing, in accordance with their reliabilities, numerical values indicating the determination results of the determining section 102A to 102C. Further, the integrative determination section 104 adds a result of the determination to the inspection result data 112.

For example, each of the determination results of the determining sections 102A to 102C can be expressed by a numerical value “−1” (a defect is absent) or “1” (a defect is present). In this case, in a case where the reliabilities are derived as numerical values ranging from 0 to 1, the determination results may be multiplied by the values of the reliabilities as weights.

Specifically, for example, assume that the determination result of the determining section 102A indicates that a defect is present, the determination result of the determining section 102B indicates that a defect is absent, and the determination result of the determining section 102C indicates that a defect is present. Assume also that the reliabilities of the determination results of the determining sections 102A to 102C are 0.87, 0.51, and 0.95, respectively. In this case, the integrative determination section 104 carries out calculation in accordance with the following expression: 1×0.87+(−1)×0.51+1×0.95. Consequently, a numerical value of 1.31 is obtained.

Then, the integrative determination section 104 compares this numerical value with a given threshold. If the calculated numerical value is higher than the threshold, the integrative determination section 104 may determine that a defect is present. In a case where the result indicating that a defect is absent is expressed by a numerical value of “−1” and the result indicating that a defect is present is expressed by a numerical value of “1”, the threshold may be set at “0”, which is an intermediate value between these numerical values. In this case, since 1.31>0, a final determination result given by the integrative determination section 104 indicates that a defect is present.

As discussed above, the determination method in accordance with the present embodiment is a determination method to be executed by the information processing device 1, the determination method including: the obtaining step (S12) of obtaining an output value given in response to inputting an inspection image into a classification model generated by carrying out learning so that distances between feature quantities extracted from an image group not having a noise (a first image group having a common feature) become small when the feature quantities are embedded in a feature space; and the determining step (S14 to S16 when the first method is applied, S17 when the second method is applied) of applying, in accordance with the output value, the first method for an inspection image not having a noise or the second method for an inspection image having a noise (a second image group constituted by an image not belonging to the first image group) to determine the presence or absence of a defect (a given determination matter relating to the inspection image). Thus, it is possible to carry out highly accurate determination even on an image which is likely to cause erroneous determination.

The inspection image not having a noise is an image for which determination, such as those executed by the determining sections 102A and 102C, on the basis of the output value given in response to inputting the inspection image into the learned model generated by machine learning is effective. Thus, as in the example shown in FIG. 6, it is preferable that the first method include at least the process of carrying out determination with use of the learned model and the second method include at least the process of carrying out the above-described numerical analysis.

The inspection image not having a noise does not include a portion similar in appearance to a defect in the inspection target. Therefore, for the inspection image not having a noise, determination with use of the learned model generated by machine learning is effective. Thus, in the case of the inspection image not having a noise, it is expected to attain a highly accurate determination result by adopting the process of carrying out determination with use of the learned model generated by machine learning.

Here, a noise is in irregular form, and is similar in appearance to a defect in the inspection target. Thus, for the inspection image having a noise, determination involving use of the learned model generated by machine learning may not be effective in some cases. However, even for such an inspection image, adoption of numerical analysis may sometimes enable appropriate determination.

Thus, with the configuration in which the second method including numerical analysis is applied to determine the presence or absence of a defect for the inspection image having a noise, an appropriate determination result can be expected even in a case where the inspection image is an image for which determination involving use of the learned model is not effective. That is, with the above configuration, either in a case where the inspection image is an image for which determination involving use of the learned model is effective or in a case where the inspection image is an image for which determination involving use of the learned model is not effective, it is possible to carry out appropriate determination.

Note that the first method only needs to include at least one determination process involving use of a learned model generated by machine learning. For example, the first method may include only one of the determination process carried out by the determining section 102A and the determination process carried out by the determining section 102C. Further, the second method may include, in addition to the determination process carried out by the determining section 102B, a determination process(es) carried out by other method(s) such as the determining sections 102A and 102C. However, in this case, it is desirable to set a weight on the determination result of the determining section 102B so as to be heavier than a weight(s) of a determination result(s) provided by any other method(s).

### Embodiment 2

The following description will discuss another embodiment of the present invention. For convenience of description, a member having a function identical to that of a member discussed in the foregoing embodiment is given an identical reference sign, and a description thereof is omitted. This applies also to Embodiments 3 and 4.

[Configuration of Device]

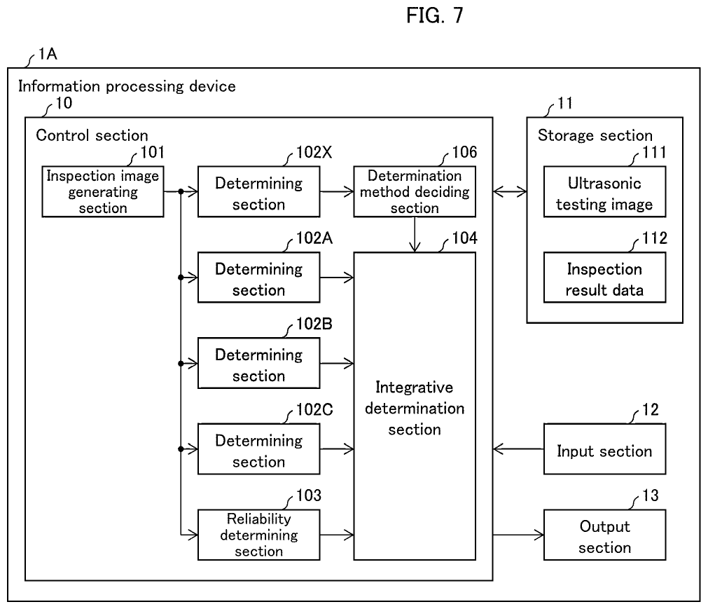

The following description will discuss, with reference to FIG. 7, a configuration of an information processing device 1A in accordance with the present embodiment. FIG. 7 is a block diagram illustrating an example of a configuration of a main part of the information processing device 1A. The information processing device 1A differs from the information processing device 1 shown in FIG. 1 in that the information processing device 1A does not include the classifying section 105 and does include a determining section 102X and a determination method deciding section (obtaining section) 106. The determining section 102X determines the presence or absence of a defect with use of the classification model explained in Embodiment 1. To be more specific, the determining section 102X determines the presence or absence of a defect on the basis of an output value given in response to inputting an inspection image into the classification model.

For example, the determining section 102X may use a classification model, such as the one shown in the example in FIG. 5, which is generated by carrying out learning so that (i) distances between feature quantities extracted from an image group not having a noise but having a defect become small and (ii) distances between feature quantities extracted from an image group not having a noise or a defect become small. The determining section 102X can determine, on the basis of an output value given in response to inputting an inspection image into the classification model, whether the inspection image is an inspection image not having a noise or a defect or an inspection image not having a noise but having a defect.

The determination method deciding section 106 obtains an output value from the classification model used by the determining section 102X for the above determination. Then, if the output value indicates that the inspection image is an inspection image not having a noise or a defect or an inspection image not having a noise but having a defect, the determination method deciding section 106 determines that the inspection image does not have a noise, and decides to apply a first method for an inspection image not having a noise. Meanwhile, if the output value indicates that the inspection image is neither an inspection image not having a noise or a defect nor an inspection image not having a noise but having a defect, the determination method deciding section 106 determines that the inspection image has a noise, and decides to apply a second method for an inspection image having a noise.

[Flow of Process]

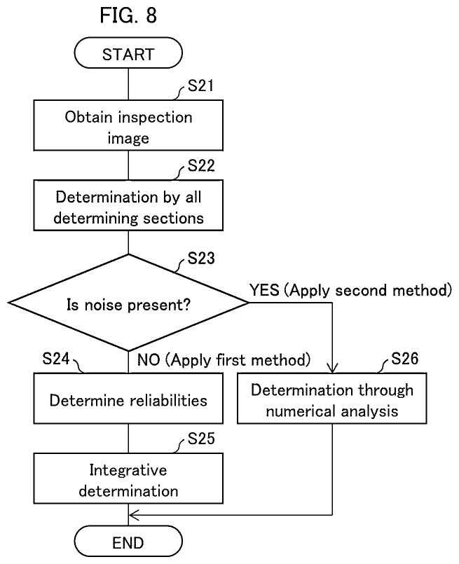

The following description will discuss, with reference to FIG. 8, a flow of a process (determination method) to be executed by the information processing device 1A. FIG. 8 is a view illustrating an example of an inspection method involving use of the information processing device 1A. Assume that, at the time of start of the process in FIG. 8, an ultrasonic testing image 111 is stored in a storage section 11, and an inspection image generating section 101 has already generated an inspection image from the ultrasonic testing image 111.

In S21, all determining sections 102, i.e., determining sections 102A, 102B, 102C, and 102X obtain the inspection image generated by the inspection image generating section 101. Then, in S22, all the determining sections 102 that have obtained the inspection image in S21 determine the presence or absence of a defect with use of the inspection image.

In S23 (obtaining step), the determination method deciding section 106 obtains an output value given in response to the determining section 102X inputting the inspection image into the classification model in S22. Then, the determination method deciding section 106 determines, on the basis of the output value thus obtained, whether the inspection image obtained in S21 is an inspection image having a noise or an inspection image not having a noise.

If the determination method deciding section 106 determines, in S23, that the inspection image is an inspection image having a noise (YES in S23), the determination method deciding section 106 instructs the determining section 102B to execute determination and the process advances to S26. Then, in S26 (determination step), determination of the presence or absence of a defect in the inspection image is carried out by the second method for an inspection image having a noise, i.e., the determining section 102B that carries out numerical analysis of pixel values in the inspection image, and a result of the determination is added to inspection result data 112.

Note that the determination by the determining section 102B has already been carried out in S22. Therefore, if the determination method deciding section 106 determines YES in S23, the process of S26 may not be carried out. Instead, the determination result given by the determining section 102 in S22 may be added to the inspection result data 112 as a final determination result.

If the determination method deciding section 106 determines, in S23, that the inspection image is an inspection image not having a noise (NO in S23), the determination method deciding section 106 instructs a reliability determining section 103 and an integrative determination section 104 to execute determination, and the process advances to S24. Then, in S24 and S25 (determination step), determination of the presence or absence of a defect in the inspection image is carried out by the first method for an inspection image not having a noise, i.e., the method of carrying out final determination by integrating the determination results obtained by a plurality of methods in S22.

Specifically, in S24, the reliability determining section 103 determines reliabilities of the determination results of the determining sections 102A, 102B, 102C, and 102X. The method for determining the reliabilities of the determination results of the determining sections 102A, 102B, and 102C are as explained in Embodiment 1. A reliability of the determination result of the determining section 102X may be determined in a similar manner to the reliability prediction model for the determining section 102A explained in Embodiment 1. That is, a reliability prediction model for the determining section 102X may be generated in advance, and determination may be carried out with use of the reliability prediction model.

Then, in S25, the integrative determination section 104 determines the presence or absence of a defect with use of the determination results obtained in S22 and the reliabilities determined in S24. Further, the integrative determination section 104 adds a result of the determination to the inspection result data 112.

The inspection image not having a noise is an image for which determination, such as those executed by the determining sections 102A and 102C, on the basis of the output value given in response to inputting the inspection image into the learned model generated by machine learning is effective. Therefore, in a case where the first method is configured as a method that carries out final determination by integrating the determination results regarding the presence or absence of a defect given by a plurality of methods, that method preferably includes a method of carrying out determination with use of a learned model generated by machine learning. Further, that method preferably includes a method of carrying out determination on the basis of an output value from the classification model, too. Moreover, in this case, the second method is preferably configured as a method of carrying out determination through numerical analysis of pixel values in the inspection image.

According to the above configuration, the first method, which is the determination method for an inspection image not having a noise, is a method of carrying out determinations with use of the plurality of methods and then carrying out final determination by integrating results of the determinations. The plurality of methods include the methods, executed by the determining sections 102A and 102C, of carrying out determinations with use of the learned model. For an inspection image not having a noise, determination involving use of the learned model is effective. Therefore, the above configuration enables highly accurate determination. Further, this determination also includes a determination result of the determining section 102X, which has determined a determination matter on the basis of an output value from the classification model. Therefore, further improvement in determination accuracy can also be expected.

Further, according to the above configuration, the second method, which is the determination method for an inspection image having a noise, the second method 102B carries out determination through numerical analysis of pixel values in an inspection image. In some cases, the determination involving use of the learned model is not effective for an inspection image having a noise. Even in such a case, numerical analysis may sometimes enable appropriate determination.

Thus, with the above configuration, either in a case where the inspection image is an image for which determination involving use of the learned model is effective or in a case where the inspection image is an image for which determination involving use of the learned model is not effective, it is possible to carry out appropriate determination.

### Embodiment 3

[Configuration of Device]

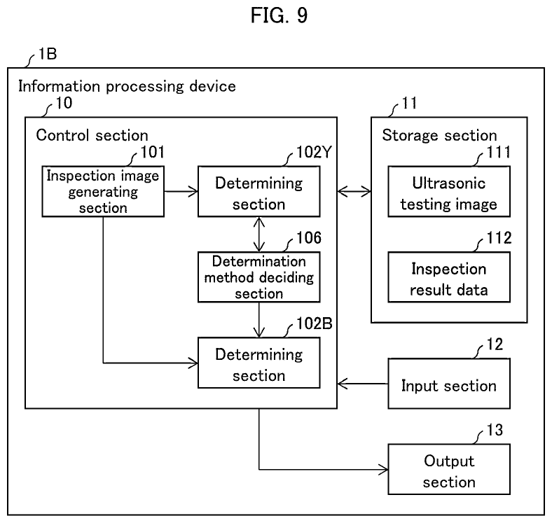

The following description will discuss, with reference to FIG. 9, a configuration of an information processing device 1B in accordance with the present embodiment. FIG. 9 is a block diagram illustrating an example of a configuration of a main part of the information processing device 1B. The information processing device 1B includes an inspection image generating section 101, a determining section 102B, a determining section 102Y, and a determination method deciding section (obtaining section) 106.

The determining section 102Y determines the presence or absence of a defect with use of a classification model, similarly to the determining section 102X of Embodiment 2. To be more specific, the determining section 102Y determines the presence or absence of a defect in accordance with an output value given in response to inputting an inspection image into the classification model.

For example, the determining section 102Y may use a classification model, such as the one shown in the example in FIG. 5, which is generated by carrying out learning so that (i) distances between feature quantities extracted from an image group not having a noise but having a defect become small and (ii) distances between feature quantities extracted from an image group not having a noise or a defect become small. The determining section 102Y can determine, on the basis of an output value given in response to inputting an inspection image into the classification model, whether the inspection image is an inspection image not having a noise or a defect or an inspection image not having a noise but having a defect.

[Flow of Process]

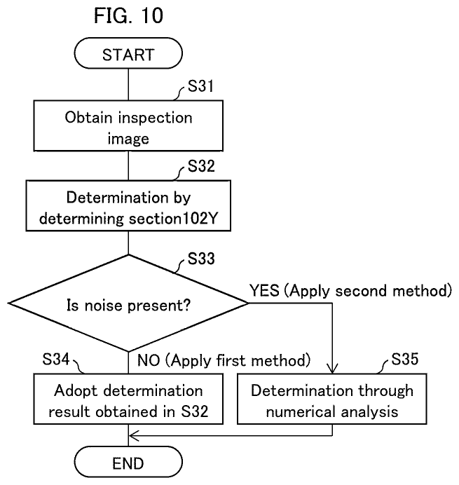

The following description will discuss, with reference to FIG. 10, a flow of a process (determination method) to be executed by the information processing device 1B. FIG. 10 is a view illustrating an example of an inspection method involving use of the information processing device 1B. Assume that, at the time of start of the process in FIG. 10, an ultrasonic testing image 111 is stored in a storage section 11, and an inspection image generating section 101 has already generated an inspection image from the ultrasonic testing image 111.

In S31, the determining section 102Y obtains the inspection image generated by the inspection image generating section 101. Then, in S32 (determination step), the determining section 102Y determines the presence or absence of a defect with use of the inspection image obtained in S31.

In S33 (obtaining step), the determination method deciding section 106 obtains an output value given in response to the determining section 102X inputting the inspection image into the classification model in S32, and determines, on the basis of the output value, whether the inspection image obtained in S31 is an inspection image having a noise or an inspection image not having a noise.

If the determination method deciding section 106 determines, in S33, that the inspection image is an inspection image having a noise (YES in S33), the determination method deciding section 106 instructs the determining section 102B to execute determination, and the process advances to S35. Then, in S35 (determination step), determination of the presence or absence of a defect in the inspection image is carried out by the second method for an inspection image having a noise, i.e., the determining section 102B that carries out numerical analysis of pixel values in the inspection image, and a result of the determination is added to inspection result data 112.

Meanwhile, if the determination method deciding section 106 determines, in S33, that the inspection image obtained is an inspection image not having a noise (NO in S33), the process advances to S34. Then, in S34, the determination method deciding section 106 adds the determination result obtained in S32 to the inspection result data 112 as a final determination result.

Similarly to Embodiments 1 and 2, the present embodiment determines the presence or absence of a defect, i.e., an abnormal portion in an inspection target included in an inspection image. A noise is similar in appearance to an abnormal portion. Therefore, in a case where a defective portion is called an abnormal portion, it can be said that an image included in an image group having a noise is an image including a pseudo abnormal portion, which is similar in appearance to the abnormal portion. Further, it can be said that an inspection image included in an image group not having a noise is an image not including a pseudo abnormal portion.

Further, the output value from the classification model used by the determining section 102Y indicates whether the inspection target image belongs to an image group having a noise, the inspection target image is an image belonging to an image group not having a noise but including an abnormal portion, or the inspection target image is an image belonging to an image group not having a noise and not including an abnormal portion. In this case, as in the above-described example, the first method may include a process of determining, on the basis of the output value from the classification model, the presence or absence of an abnormal portion in the inspection target. Further, the second method may include a process of determining the presence or absence of an abnormal portion in the inspection target through numerical analysis of pixel values in the inspection image.

With the above configuration, for an inspection image included in an image group not having a noise, the first method is applied, and the presence or absence of an abnormal portion is determined on the basis of the output value from the classification model. As discussed above, the classification model is generated by carrying out learning so that (i) distances between feature quantities extracted from an image group not having a noise but having a defect become small and (ii) distances between feature quantities extracted from an image group not having a noise or a defect become small. Thus, carrying out determination with use of the classification model makes it possible to determine, with high accuracy, whether the inspection image is an image not having a noise but having a defect or an image not having a noise or a defect.

Note that, even with use of the classification model, it may be difficult to distinguish a pseudo abnormal portion and an abnormal portion from each other. In order to deal with this, according to the above configuration, for an inspection image for which an output value from the classification model indicates that the inspection image belongs to an image having a noise (second image group), that is, the inspection image including a pseudo abnormal portion, the determining section 102B carries out numerical analysis of pixel values in the inspection image to determine the presence or absence of an abnormal portion in the inspection target. With this, even for an inspection image including a pseudo abnormal portion, which is difficult to be distinguished from the abnormal portion, it is possible to determine the presence or absence of the abnormal portion with high accuracy.

Thus, the above configuration enables to carry out appropriate determination either for an inspection image including a pseudo abnormal portion and an inspection image not including a pseudo abnormal portion. Of course, the first method may include a determination process carried out by the determining section 102B as well as a determination process(es) carried out by the determining sections 102A, 102C, and other section(s) explained in Embodiment 1. Similarly, the second method may include, in addition to the determination process carried out by the determining section 102B, a determination process(es) carried out by the determining sections 102A, 102C, and other section(s) explained in Embodiment 1.

Note that, in S32, the determining section 102Y may carry out determination with use of a classification model that classifies inspection images into four classes, i.e., a class not having a noise but having a defect, a class not having a noise or a defect, a class having a noise and a defect, and a class having a noise but not having a defect. Such a classification model can be generated by carrying out learning so that distances between feature quantities extracted from an image group having a noise and a defect become small and distances between feature quantities extracted from an image group having a noise but not having a defect become small.

In this case, in S35, both of (i) the determination result, given by the determining section 102Y, indicating that the inspection image is an image having a noise and a defect or an image having a noise but not having a defect and (ii) the determination result, given by the determining section 102B, indicating the presence or absence of a defect may be given as a final determination result. Further, these determination results may be integrated to yield a final determination result. The plurality of determination results can be integrated on the basis of reliabilities, for example, in a similar manner to Embodiments 1 and 2. However, in this case, it is desirable to set a weight on the determination result of the determining section 102B so as to be heavier than a weight on a determination result of the determining section 102Y.

### Embodiment 4

[Configuration of Device]

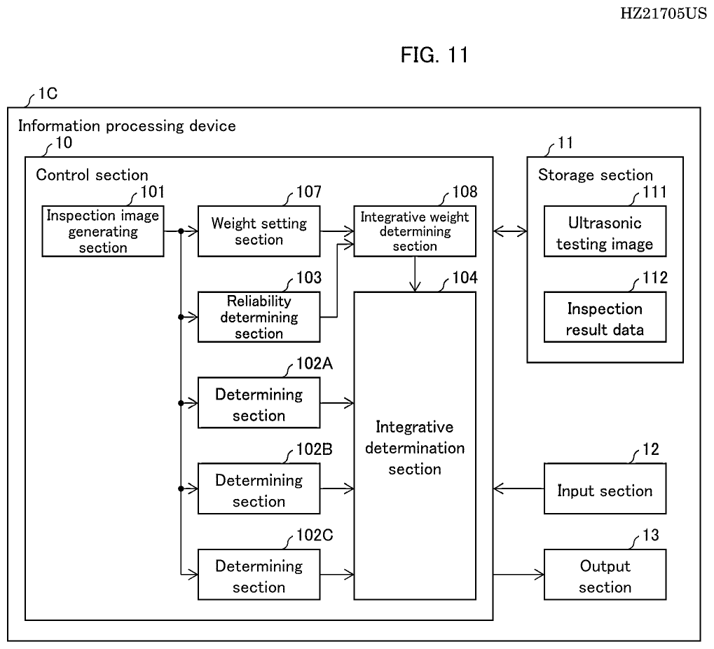

The following description will discuss, with reference to FIG. 11, a configuration of an information processing device 1C in accordance with the present embodiment. FIG. 11 is a block diagram illustrating an example of a configuration of a main part of the information processing device 1C. The information processing device 1C includes an inspection image generating section 101, determining sections 102A to 102C, a reliability determining section 103, an integrative determination section 104, a weight setting section (obtaining section) 107, and an integrative weight determining section 108.

The weight setting section 107 obtains an output value given in response to inputting a target image into a classification model generated by carrying out learning so that feature quantities extracted from an image group not having a noise (first image group having a common feature) become small when the feature quantities are embedded in a feature space.

Then, the weight setting section 107 sets, on the basis out the output value thus obtained, weights on determination results, the weights being used in integration of the determination results of the determining section 102A to 102C. Specifically, in a case where the first method for an inspection image not having a noise is applied, the weight setting section 107 sets weights on the determination results of the determining sections 102A and 102C, each of which uses a learned model generated by machine learning, so as to be heavier than a weight on the determination result of the determining section 102B, which uses the method carrying out numerical analysis. Meanwhile, in a case where the second method for an inspection image having a noise is applied, the weight setting section 107 sets a weight on the determination result of the determining section 102B so as to heavier than weights on the determination results of the determining sections 102A and 102C.

Note that a specific method of deciding a weighting value may be set in advance. For example, assume that the weight setting section 107 uses a classification model, such as the one shown in the example in FIG. 5, which is generated by carrying out learning so that (i) distances between feature quantities extracted from an image group not having a noise but having a defect become small and (ii) distances between feature quantities extracted from an image group not having a noise or a defect become small.

In this case, the weight setting section 107 may use a given mathematical formula to convert a coordinate value, in the feature space, of a plot of a feature quantity extracted from the inspection image into a weighting value of not less than 0 and not more than 1. In this case, the weighting value is calculated in the following manner, for example: (1) Calculate a distance in the feature space from (i) a location of the plot of the feature quantity extracted from the inspection image to (ii) a point P1, which is a center point of the class not having a noise or a defect; (2) In a similar manner to (1), calculate a distance from (i) the location of the plot of the feature quantity extracted from the inspection image to (ii) a point P2, which is a center point of the class not having a noise but having a defect; (3) Calculate a weighting value by substituting, in a predetermined mathematical formula, shorter one of the distances thus calculated.

The mathematical formula is a function having the above distance and the weight value as variants. In the mathematical formula, shorter the distance is, the greater the weighting values for the determination results of the determining sections 102A and 102C become. Further, in a case where a distance shorter than the radius r1 or r2 is substituted in this mathematical formula, weighting values equal to or heavier than a weighting value of the determination result of the determining section 102B are derived for the determination results of the determining sections 102A and 102C. Note that the “equal” value includes the same value. Meanwhile, in a case where a distance longer than the radius r1 or r2 is substituted in this mathematical formula, weighting values equal lighter than a weighting value of the determination result of the determining section 102B are derived for the determination results of the determining sections 102A and 102C.

Further, the weight setting section 107 may decide the weighting values with use of, e.g., a method similar to the method according to which the reliability determining section 103 determines a reliability. In this case, the weight setting section 107 calculates, with use of the reliability prediction model for the determining section 102X explained in Embodiment 2, a reliability of an output value from the classification model. Then, as the calculated reliability becomes higher, the weight setting section 107 may set heavier weighting values for the determination results of the determining sections 102A and 102C.

With this, for an inspection image which is similar to an image whose rate of success in classification by the classification model was high and for which appropriate determination results are likely to be given by the determining sections 102A and 102C, heavier weighting values are given to the determination results of the determining sections 102A and 102C. Meanwhile, for an inspection image which is not similar to the above image and for which inappropriate determination results are likely to be given by the determining sections 102A and 102C, a heavier weighting value is given to the determination result of the determining section 102B.

Further, for example, in a case where the output value from the classification model is a value indicating a certainty that the inspection image is an image without a noise, the weight setting section 107 may set weights on the determination results at given values determined on the basis of whether or not the certainty is not less than a given threshold. For example, in a case where the certainty is not less than 0.8, the weight setting section 107 may set each of the weights on the determining sections 102A and 102C at 0.4 and may set the weight on the determining section 102B at 0.2. In this case, in a case where the certainty is less than 0.8, the weight setting section 107 may set each of the weights on the determining sections 102A and 102C at 0.2 and may set the weight on the determining section 102B at 0.6.

The integrative weight determining section 108 calculates, with use of the weights set by the weight setting section 107 and the reliabilities determined by the reliability determining section 103, weights used in integration of the determination results of the determining sections 102A to 102C (hereinafter, such weights will be called “integrative weights”). Each of the integrative weights may be the one in which both (i) the weight set by the weight setting section 107 and (ii) the reliability determined by the reliability determining section 103 are reflected. For example, the integrative weight determining section 108 may derive, as the integrative weight, a number-based arithmetical mean of the weight set by the weight setting section 107 and the reliability determined by the reliability determining section 103.

[Flow of Process]

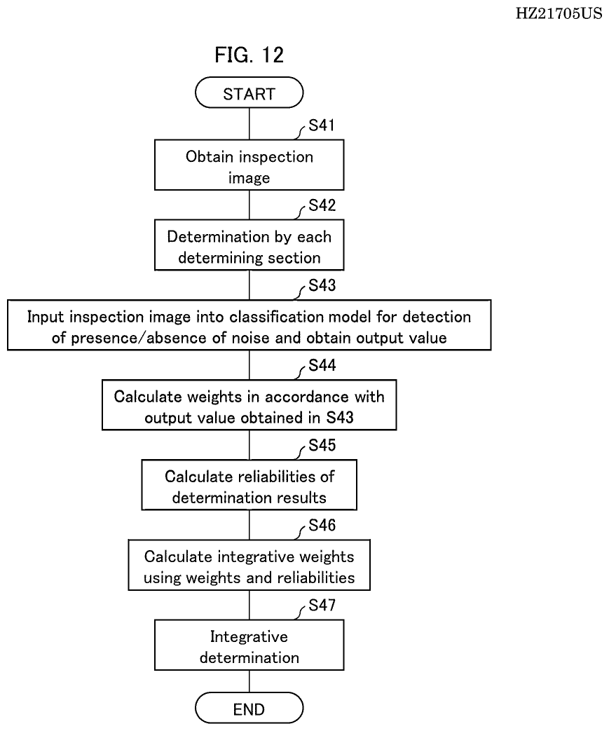

The following description will discuss, with reference to FIG. 12, a flow of a process (determination method) to be executed by the information processing device 1C. FIG. 12 is a view illustrating an example of an inspection method involving use of the information processing device 1C. Assume that, at the time of start of the process in FIG. 12, an ultrasonic testing image 111 is stored in a storage section 11, and an inspection image generating section 101 has already generated an inspection image from the ultrasonic testing image 111.

In S41, all determining sections 102, i.e., determining sections 102A, 102B, and 102C obtain the inspection image generated by the inspection image generating section 101. Further, the weight setting section 107 and the reliability determining section 103 also obtain the inspection image. Then, in S42, all the determining sections 102 that have obtained the inspection image in S41 determine the presence or absence of a defect with use of the inspection image.

In S43 (obtaining step), the weight setting section 107 inputs the inspection image obtained in S41 into the classification model and obtains an output value given in response to this. Then, in S44, the weight setting section 107 calculates weights in accordance with the output value obtained in S43.

Specifically, in a case where the output value obtained in S43 indicates that the inspection image is an image not having a noise, the weight setting section 107 sets weights on the determination results of the determining sections 102A and 102C so as to be heavier than a weight on the determination result of the determining section 102B. Meanwhile, in a case where the output value obtained in S43 indicates that the inspection image is an image having a noise, the weight setting section 107 sets a weight on the determination result of the determining section 102B so as to be heavier than weights on the determination results of the determining sections 102A and 102B.

In S45, the reliability determining section 103 determines reliabilities of the determination results of the determining sections 102A, 102B, and 102C. Note that the process in S45 may be carried out before S42 to S44 or in parallel with any of S42 to S44.

In S46, the integrative weight determining section 108 calculates an integrative weight with use of the weights calculated in S44 and the reliabilities calculated in S45. For example, assume that weights on the determining sections 102A to 102C are respectively set at 0.2, 0.7, and 0.1 and the reliabilities thereof are respectively set at 0.3, 0.4, and 0.3. In this case, the integrative weight determining section 108 may calculate the integrative weights of the determining sections 102A to 102C at 0.25, 0.55, and 0.2, respectively.

In S47, the integrative determination section 104 determines the presence or absence of a defect with use of the determination results obtained in S42 and the integrative weights calculated in S46. Note that the determination involving use of the integrative weights is similar to the determinations involving use of the reliabilities explained in Embodiments 1 and 2. Further, the integrative determination section 104 adds a result of the determination to the inspection result data 112.

The inspection image not having a noise is an image for which determination, such as those executed by the determining sections 102A and 102C, on the basis of the output value given in response to inputting the inspection image into a learned model generated by machine learning is effective. Therefore, in a case where the first method is configured as a method that carries out final determination by integrating the determination results regarding the presence or absence of a defect given by a plurality of methods, the methods preferably include a method of carrying out determination with use of a learned model generated by machine learning. The methods method may also include a method of carrying out determination through numerical analysis of pixel values in the inspection image.

In this case, when the first method for the inspection image not having a noise is applied, the weight setting section 107 preferably sets weights on the determination results of the determining sections 102A and 102C, each of which uses the learned model, so as to be equal to or heavier than a weight on the determination result of the determining section 102B, which carries out numerical analysis. Basically, the weight setting section 107 may set equal weights on the determination results so that a final determination result is derived on the basis of the reliabilities determined by the reliability determining section 103. Meanwhile, when the second method for the inspection image having a noise is applied, the weight setting section 107 preferably sets a weight on the determination result of the determining section 102B, which carries out numerical analysis, so as to be heavier than weights on the determination results of the determining sections 102A and 102C, each of which uses the learned model.

According to the above configuration, when the first method, which is the determination method for the inspection image not having a noise, is applied, a weight on a determination result given by a method that uses a learned model generated by machine learning is set so as to be equal to or heavier than a weight on a determination result given by a method that carries out numerical analysis. For the inspection image not having a noise, determination involving use of the learned model generated by machine learning is effective. Therefore, the above configuration enables highly accurate determination.

According to the above configuration, when the second method, which is the determination method for the inspection image having a noise, is applied, a weight on the determination result given by the method that carries out numerical analysis is set so as to be heavier than a weight on the determination result given by the method that uses the learned model. In some cases, the determination involving use of the learned model is not effective for the inspection image having a noise. Even in such a case, numerical analysis may sometimes makes it possible to carry out appropriate determination. Therefore, the above configuration can increase the possibility of obtaining an appropriate determination result.

Thus, with the above configuration, either in a case where the inspection image is an image for which determination involving use of the learned model is effective or in a case where the inspection image is an image for which determination involving use of the learned model is not effective, it is possible to carry out appropriate determination.

Further, as discussed above, the information processing device 1C includes the reliability determining section 103 that determines the reliabilities of the determining sections 102 on the basis of the inspection image. Then, the integrative determination section 104 carries out determination with use of the determination results given by the determining sections 102, the reliabilities determined by the reliability determining section 103, and the weights set by the weight setting section 107. With this configuration, it is possible to derive a final determination result in appropriate consideration of the determination results on the basis of the inspection image.

[Determination of Type of Defect]

The foregoing embodiments have dealt with cases where the presence or absence of a defect is determined. In addition to or instead of the determination of the presence or absence of a defect, the type of the defect may be determined. For example, in Embodiment 1, an inspection image determined to have a defect may be inputted into a type determination model for determining the type of a defect, and the type of the defect may be determined on the basis of an output value from the type determination model. The type determination model can be constructed by carrying out machine learning by using, as training data, an image including a defect of a known type. Further, the type can be determined through image analysis and/or the like, instead of use of the type determination model. Further, the determination may be carried out by the determining section 102 with use of the type determination model.

Also in Embodiment 2, determination may be carried out by the determining sections 102A to 102C with use of the type determination model. In this case, the classification model to be used by the determining section 102X may be a model that carries out classification on the basis of the presence or absence of a noise as well as the presence or absence of a defect and the type of the defect. In learning of this model, a distance between feature quantities may be represented by a Euclidean distance or the like or by an angle. This applies also to Embodiment 3. The determining section 102Y may determine the type of the defect.

[Example Applications]

The foregoing examples have dealt with the example in which the presence or absence of a defect in the tube-to-tubesheet weld is determined on the basis of the ultrasonic testing image 111. The determination matter may be selected arbitrarily. The target image to be used for the determination may be any image selected according to the determination matter. The determination matter and the target image are not limited to those explained in the foregoing embodiments.

For example, the information processing device 1 is applicable also to an inspection for determining the presence or absence of a defect (which may also be called “abnormal portion”) in an inspection target in radiographic testing (RT). In this case, an image related to an abnormal portion is detected from, in place of a radiograph, image data obtained with use of an electric device such as an imaging plate. Thus, the information processing devices 1, 1A, 1B, and 1C are applicable to various kinds of nondestructive inspections that use various data. Furthermore, the information processing devices 1, 1A, 1B, and 1C are applicable to, in addition to the nondestructive inspections, detection of an object in a still image or a moving image and classification of the detected object, for example.

[Variation 1]

The foregoing embodiments have dealt with the example in which an output value given in response to inputting an inspection image into a reliability prediction model is used as a reliability. However, the present invention is not limited to this example. The reliability may be any one, provided that it is derived from data having been used by the determining section 102 for determination.

For example, in a case where the determining section 102B determines the presence or absence of a defect with use of a binarized image obtained by binarizing an inspection image, the reliability prediction model for the determining section 102B may be a model that accepts a binarized image as input data. Meanwhile, in this case, if the determining section 102C determines the presence or absence of a defect with use of the inspection image as it is, the reliability prediction model for the determining section 102C may be a model that accepts an inspection image as input data. Thus, the reliability prediction models for the determining sections 102 do not need to be constructed to accept completely the same input data.

Embodiment 1 has dealt with the example in which the three determining sections 102 are employed. Alternatively, the number of determining sections 102 may be two or four or more. Further, in Embodiment 1, the determination methods of the three determining sections 102 differ from each other. Alternatively, the determination methods of the three determining sections 102 may be the same. Determining sections 102 configured to carry out the same determination method may be configured to use different thresholds for determination and/or different training data to construct learned models for determination. This is also true of Embodiments 2 and 4. A total number of determining sections 102 to be used only needs to be two or more.

An entity that executes each process described in each of the foregoing embodiments can be changed as appropriate. For example, all of or a part of the processes in S12 (classification on the basis of the presence or absence of a noise), S14 (determinations by the determining sections 102), S15 (determination of reliabilities), and S16 (integrative determination) in the flowchart shown in FIG. 6 may be executed by another information processing device. Similarly, a part or all of the processes to be executed by the determining sections 102A to 102C may be executed by another information processing device. In these cases, the number of another information processing device(s) may be one or two or more. As discussed above, the functions of the information processing device 1 can be realized by wide variety of system configurations. In a case where a system including a plurality of information processing devices is constructed, some of the plurality of information processing devices may be provided on cloud. That is, the functions of the information processing device 1 can also be realized by one information processing device or a plurality of information processing devices carrying out information processing online. This is also true of the information processing devices 1A, 1B, and 1C.

[Variation 2]

The learned model explained in the foregoing embodiments can be constructed with use of, instead of an actual inspection image, fake (false) data or synthetic data similar to the inspection image. The fake data or the synthetic data may be generated with use of a generation model constructed by machine learning, for example. Alternatively, the fake data or the synthetic data may be generated by manually integrating images. Further, in construction of the learned model, these pieces of data may be subjected to data augmentation to enhance the determination performance.

[Software Implementation Example]

The functions of the information processing devices 1, 1A, 1B, and 1C (hereinafter, referred to as a “device”) can be realized by a program (determination program) causing a computer to function as the device, the program causing the computer to function as each of the control blocks (particularly, each of the sections included in the control section 10) of the device.

In this case, the above device includes, as hardware for executing the program, a computer including at least one control device (e.g., a processor) and at least one storage device (e.g., a memory). When the control device and the storage device execute the program, the functions explained in the foregoing embodiments are realized.

The program may be stored in one or more non-transitory, computer readable storage media. The one or more storage media may be or may not be included in the device. In the latter case, the program may be supplied to the device via any wired or wireless transmission medium.

A part of or all of the functions of the control blocks can be realized by a logical circuit. For example, an integrated circuit on which a logical circuit functioning as the control blocks is formed may also be encompassed in the present invention. Further, the functions of the control blocks can be realized by a quantum computer, for example.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 1A, 1B, 1C: information processing device
102 (102A, 102B, 102C, 102X, 102Y): determining section
103: reliability determining section
104: integrative determination section (determining section)
105: classifying section (obtaining section)
106: determination method deciding section (obtaining section)
107: weight setting section (obtaining section)

1. An information processing device comprising:
an obtaining section that obtains an output value given in response to inputting a target image into a classification model generated by carrying out learning so that distances between feature quantities extracted from a first image group having a common feature become small when the feature quantities are embedded in a feature space; and
a determining section that applies, on a basis of the output value, a first method for the first image group or a second method for a second image group, which is constituted by an image not belonging to the first image group, to determine a given determination matter relating to the target image.

2. The information processing device according to claim 1, wherein:
the first image group is an image group for which determination on a basis of an output value given in response to inputting the target image into a learned model generated by machine learning is effective;
the first method includes at least a process of determining the determination matter with use of the learned model; and
the second method includes at least a process of determining the determination matter through numerical analysis of pixel values in the target image.

3. The information processing device according to claim 1, wherein:
the first image group is an image group for which determination on a basis of an output value given in response to inputting the target image into a learned model generated by machine learning is effective;
the first method is a method of determining the determination matter with use of a plurality of methods and then integrating results of the determinations to carry out final determination;
the plurality of methods include
a method of determining the determination matter with use of the learned model and
a method of determining the determination matter on a basis of the output value from the classification model; and
the second method is a method of determining the determination matter through numerical analysis of pixel values in the target image.

4. The information processing device according to claim 1, wherein:
the given determination matter is presence or absence of an abnormal portion in a target in the target image;
an image included in the first image group is an image of a target which does not include a pseudo abnormal portion similar in appearance to the abnormal portion;
an image included in the second image group is an image of a target including the pseudo abnormal portion;
the output value from the classification model indicates whether the target image belongs to the second image group, the target image is an image belonging to the first image group and including the abnormal portion, or the target image is an image belonging to the first image group and not including the abnormal portion;
the first method includes at least a process of determining presence or absence of the abnormal portion in the target on a basis of the output value; and
the second method includes at least a process of determining presence or absence of the abnormal portion in the target through numerical analysis of pixel values in the target image.

5. The information processing device according to claim 1, wherein:
the first image group is an image group for which determination on a basis of an output value given in response to inputting the target image into a learned model generated by machine learning is effective;
the determination section determines the determination matter by a plurality of methods and then synthesizes results of the determinations to determine the determination matter;
the plurality of methods include a method of determining the determination matter with use of the learned model and a method of determining the determination matter through numerical analysis of pixel values in the target image;
the information processing device further comprises a weight setting section that sets weights on the results of the determinations, the weights being used in integration of the results of the determinations;
in a case where the first method is applied, the weight setting section sets a weight on the result of the determination given by the method involving use of the learned model so as to be equal to or heavier than a weight on the result of the determination given by the method carrying out the numerical analysis; and
in a case where the second method is applied, the weight setting sections sets a weight on the result of the determination given by the method carrying out the numerical analysis so as to be heavier than a weight on the result of the determination given by the method involving use of the learned model.

6. The information processing device according to claim 5, further comprising:
a reliability determining section that carries out, for each of the plurality of methods, a process of determining, on a basis of the target image, a reliability which is an indicator indicating a degree of certainty of the result of the determination, wherein
the determining section determines the determination matter with use of the results of the determinations, the reliabilities determined by the reliability determining section, and the weights set by the weight setting section.

7. A determination method executed by an information processing device, comprising:
an obtaining step of obtaining an output value given in response to inputting a target image into a classification model generated by carrying out learning so that distances between feature quantities extracted from a first image group having a common feature become small when the feature quantities are embedded in a feature space; and
a determination step of applying, on a basis of the output value, a first method for the first image group or a second method for a second image group, which is constituted by an image not belonging to the first image group, to determine a given determination matter relating to the target image.

8. A computer-readable, non-transitory storage medium in which a determination program is stored, the determination program causing a computer to function as an information processing device recited in claim 1, the determination program causing the computer to function as the obtaining section and the determining section.
